(19) United States
(12) Patent Application Publication
(10) Pub. No.: US 2026/0028915 A1
(43) Pub. Date: Jan. 29, 2026

(54) Sealing device, turbomachine, and use

(71) Applicant: MTU Aero Engines AG, Muenchen (DE)

(72) Inventor: Matthias SIEBEL, Munich (DE)

(21) Appl. No.: 19/305,837

(22) Filed: Aug. 21, 2025

(30) Foreign Application Priority Data
Sep. 3, 2024 (DE) 102024125115.8

(51) Int. Cl. F01D 11/00

(52) U.S. Cl. CPC F01D 11/003; F05D 2220/323; F05D 2240/56

(57) ABSTRACT

A sealing device (10), in particular a sealing device (10) of a turbomachine, including at least one brush element (18) for sealing a gap (14) between a first component (16a) and a second component (16b). The first component (16a) and the second component (16b) are rotor components.

This claims the benefit of German Patent Application 102024125115.8, filed on Sep. 3, 2024.

The present invention relates to a sealing device including at least one brush element for sealing a gap between a first component and a second component.

### BACKGROUND

In particular, during operation of turbomachines, any gaps through which the working fluid may escape are avoided or at least kept as small as possible in order to achieve the highest possible efficiency. This can limit unwanted leakage of working fluid. This applies in particular also within a turbomachine or other machines which, in particular, have a gas flow therethrough, and to gaps between two components which are disposed such that they are immovable relative to each other during operation, substantially without the relative position of the two components changing during normal operation. For example, the prior art has described sealing devices (see FIG. 1) where sealing between two components which are disposed such that they are immovable relative to each other during operation is achieved by means of a sealing ring.

Such sealing elements provide a seal between at least two zones which are at different pressures. Even high temperature differences are partially isolated from each other by the sealing ring. However, as is known from the prior art (see FIG. 1), such isolation is susceptible to wear.

### SUMMARY OF THE INVENTION

Due to physical boundary conditions, such as relative movement, air flow, large pressure differences and oscillations, the sealing ring can be subject to fretting wear and lead to leakage between the two pressure zones after a relatively short time.

It is an object of the present invention to provide an improved sealing device, in particular for a turbomachine, which provides a seal between at least two pressure zones with different temperatures and/or different pressures in a particularly simple, cost-effective, and low-wear manner. This is achieved in accordance with the invention by the teaching of the independent claims. Advantageous embodiments are the subject matter of the dependent claims.

The present invention provides a sealing device, in particular a sealing device of a turbomachine, including at least one brush element for sealing a gap between a first component and a second component that are preferably disposed such that they are immovable relative to each other during operation, substantially without the relative position of the two components changing during normal operation. To form a brush seal, the brush element is attached or fixed to the first component and rests against or contacts a sealing surface of the second component in order to seal off two pressure zones with different pressures from each other during normal operation.

The two components forming the gap are preferably disposed such that they are immovable relative to each other during operation, substantially without the relative position of the two components changing during normal operation. Minor relative movements or changes in position with respect to each other, which may be caused, for example, thermally, by centrifugal force, or by stress, for example in the millimeter range, can occur during normal operation without impairing functionality and/or without the change being substantial. In this context, “substantially” can in particular mean that a movement of these two components relative to each other, for example in an axial and/or radial direction, is less than 2 mm, in particular less than 1 mm. Furthermore, in a turbomachine, movement in a radial direction of the two components is preferably limited to less than 2 mm, particularly to less than 1 mm, and in particular to less than 0.7 mm.

If reference is made to an axial and/or radial direction, these directions are perpendicular to each other, with the radial direction in particular being rotatable about an axial direction or axis. In a turbomachine, the axial direction corresponds to the direction of the axis of rotation the rotor. In the context of this invention, the terms “radial” and “axial” are understood to also refer to directions or extensions that deviate from an ideal axial or ideal radial direction of extension, for example in a single-digit range of angular degrees, and accordingly are oriented substantially axially or radially.

The definition of these directions also defines a possible movement of the two components relative to each other. This also means that the two components remain in a substantially quasi-static position relative to each other during operation of a turbomachine or another machine which, in particular, has a gas flow therethrough.

A brush seal is formed by the brush element resting against or contacting a sealing surface of the second component. This provides a form-fitting connection between the brush element and the sealing surface, which allows two pressure zones to be isolated from each other as completely as possible in terms of pressure and temperature. In other words, the brush element is pushed or pressed, in particular at an angle, against the sealing surface in such a way that pressure isolation and in particular also temperature isolation can be achieved.

The proposed design enables two pressure zones to be sealed off from each other—substantially, and in particular completely—by means of the brush element described herein.

The first component and the second component are rotor components. These components may be fixedly mounted on the rotor or form part of the rotor and rotate together accordingly. During normal operation, relative movement between these components can only occur because of the external forces acting on them, in particular due to rotational movement, which can lead to different deformations of the components and cause relative movement between them. The proposed sealing device is in particular suited to provide an improved seal between rotor components. The first component may be a shaft and/or the second component may be a disk or blisk (bladed disk).

During operation, the first component and the second component can in particular rotate at the same speed.

In an embodiment of the sealing device, the brush element is pressed against the sealing surface of the second component by the pressure difference between the two pressure zones with different pressures. As the pressure difference increases, the force that presses the brush element against the sealing surface also increases, which in turn improves the sealing of the pressure and/or temperature of the two pressure zones. Such an arrangement results in a self-intensifying effect of the brush seal. A pressure difference between the two pressure zones may have a ratio P1/P2 between 3 and 12, in particular between 4 and 11, and, for example, of about 8.5.

A brush element may be composed of a plurality of individual fibers or bristles arranged into a fiber bundle. Preferably, these individual fibers lie approximately parallel to each other. The fiber bundles are in turn braided or twisted together into a fiber package. The fiber bundle itself is at least partially guided and held within a housing. The housing allows the fiber bundle to be form-fittingly pushed or pressed against the outer surface of the second component in a pressure-sealing and preferably also thermally-sealing manner.

In accordance with an embodiment, a wire package of the brush seal rests against or is positionable to rest against the sealing surface of the second component at an angle between 10° and 90°, in particular an angle of 10°, 15°, 20°, 25°, 30°, 35°, 40°, 45°, 50°, 55°, 60°, 65°, 70°, 75°, 80°, 85°, or 90°, and at corresponding intermediate angles. Due to the here described angular engagement of the fibers or bristles of the brush element, a contact pressure produced at least in an angular component in the direction of the first component is achieved. [sic]

In a preferred embodiment, the angle is 90°±15°, preferably ±10°, especially preferably ±5°, in particular ±3°.

In an embodiment, the brush seal is used to seal a radial gap, in particular of a turbomachine. The first and second components are typically arranged at least partially coaxially in an at least overlapping axial section in such a way that the radial gap is formed in particular by an inner circumferential surface formed on one component and an outer circumferential surface formed on the other component.

A radial direction extends perpendicular to an axis of rotation of a rotor, the radial direction or at least one component extending at least partially in the radial direction being rotatable about the axis of rotation in at least one embodiment. This results in a peripheral speed at the periphery or at a portion of the component extending radially from the axis of rotation. A distance between the outer circumferential surface formed on one component and the inner surface of another component disposed circumferentially therearound forms a radial gap through which a flow can pass. In a turbomachine, such flow is in particular in the direction of the axis of rotation. In this context, the terms “radial” and “axial” are understood to also refer to directions or extensions that deviate from an ideal axial or ideal radial direction of extension, in particular in a single-digit range of angular degrees, or are oriented “substantially axially” and “substantially radially,” at least in portions hereof, but in any case are arranged in a predominantly “radial” or “axial” direction of extension (inclined by an angle greater than or less than 45° to the axis of rotation).

In at least one embodiment, the first component and/or the second component may belong to a static and/or dynamic system of a turbomachine.

In accordance with an embodiment, the brush element is quasi-statically disposed between the two components, the two components moving together substantially without the relative position of the two components being changed or changeable. In a quasi-static arrangement, both components move relative to an outside reference point, for example in the sense of rotation, but these two components are substantially immovable with respect to each other, i.e., relative to each other.

In an embodiment, a stop element is disposed on the first component on a side of the brush element opposite the gap in order to fix the brush element in place and prevent it from shifting. In other words, the stop element ensures that the brush element is constantly held in a fixed position within the above-mentioned limits of freedom of movement. In order to stabilize and fix the brush element in place outwardly from the gap, i.e., in the direction away from the second component, and in particular also to place or press it against the second component, a stop element as described herein is disposed on the first component on the side of the brush element opposite the second component.

In an embodiment of the sealing device, the brush element may include a thermoplastic, a meta-aramid, polyether ether ketone (PEEK), ceramic, and/or a metal, or may be formed from one of the aforementioned materials or a combination thereof. The material is selected based on the expected operating temperatures and the forces acting on the brush element.

The invention described herein further relates to a turbomachine, in particular an aircraft engine, having at least one sealing device according to at least one of the embodiments described above, which is suitable and designed to seal off two pressure zones with different pressures (P1, P2) from each other.

Moreover, the present invention relates to a use of a sealing device according to at least one of the embodiments described above in a turbomachine, in particular in an aircraft engine.

### BRIEF DESCRIPTION OF THE DRAWINGS

Further features, advantages, and possible applications of the invention will be apparent from the following description taken in conjunction with the figures, in which:

FIG. 1 is a sectional view of an exemplary sealing device 10 within a compressor in accordance with the prior art; and

FIG. 2 is a sectional view of an exemplary inventive sealing device 10 having a brush seal in accordance with the invention.

FIG. 3 is a sectional view of an exemplary inventive sealing device 110 according to a second embodiment having an exemplary brush seal according to the invention.

FIG. 4 is a sectional view of an exemplary inventive sealing device 210 according to a second third embodiment having an exemplary brush seal according to the invention.

### DETAILED DESCRIPTION

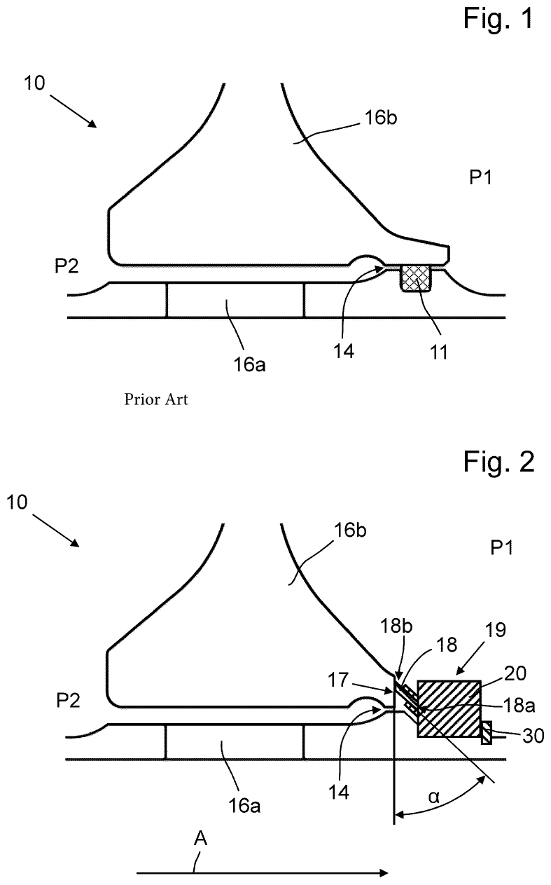

FIG. 1 shows, in sectional view, an exemplary sealing device 10, in particular a sealing device 10 of a turbomachine, in accordance with the prior art, which is shown to seal a radial gap between two components 16a, 16b of the turbomachine.

A sealing ring 11 can be seen between the two components 16a, 16b, which seals off a first pressure zone P1 and a second pressure zone P2. Such a seal is in particular also a thermal seal, so that different temperatures can be maintained within the different pressure zones without a significant or even any temperature gradient forming between the two pressure zones. However, such sealing rings 11 are susceptible to wear. This is due to relative movements of the air flow, large pressure differences, and vibrations within a turbomachine or other machines which, in particular, have a gas flow therethrough. A sealing ring 11 disposed between first component 16a and second component 16b is therefore not readily suitable for long-term operation.

FIG. 2 shows, in sectional view, an exemplary sealing device 10 according to the invention. This sealing device differs from the prior art sealing device 10 shown in FIG. 1, inter alia, in that a brush element 18 is disposed outside the gap 14 to be sealed between first component 16a and second component 16b in order to form a brush seal 19.

In FIG. 2, there is shown an exemplary inventive sealing device 10, in particular for sealing a radial gap 14 between a first component 16a and a second component 16b of or within a turbomachine, the sealing device including at least one brush element 18 for forming a brush seal 19, which has a first end region 18a fixed to a housing 20 and a second end region 18b that can be placed against a sealing surface 17 of second component 16b. At its first end region 18a, brush element 18 is held to a housing 20. Brush element 18 is quasi-statically disposed between the two components 16a and 16b in order to seal off the two pressure zones with different pressures P1, P2 from each other, the two components 16a, 16b moving together substantially without the relative position of the two components 16a, 16b being changed or changeable.

The sealing device 10 shown in FIG. 2 has a brush seal 19 that isolates the two pressure zones, which are at a pressure P1 and a pressure P2, from each other by means of brush element 18, both in terms of pressure and, for example, also in terms of temperature. The gap 14 shown in FIG. 2 represents a radial gap, in particular of a turbomachine. As illustrated, first component 16a and second component 16b are arranged coaxially in an overlapping axial section of a turbomachine in such a way that radial gap 14 is formed in particular by an inner circumferential surface formed on second component 16b and an outer circumferential surface formed on first component 16a. The direction of the axis of rotation A of the turbomachine is indicated in FIG. 2 by the arrow.

A pressure difference between the two pressures P1 and P2 may have a ratio P1/P2 between 3 and 12, preferably between 4 and 11, for example, of about 8.5. The pressure in zone P1 can therefore be higher than the pressure in zone P2 by the corresponding factor. This means that brush element 2 which, in FIG. 2, is placed at an angle α against sealing surface 17 of second component 16b is pressed thereagainst already by the pressure difference between the two pressures P1 and P2, but in particular not solely by this pressure difference.

Therefore, a contact pressure can be ensured not only by the angular engagement and positional fixation by a stop element 30, but at least partially also by the corresponding pressure differences. Pressure P1 can press brush element 18 against sealing surface 17 if pressure P1 is greater than pressure P2. FIG. 2 already shows schematically that a brush element 18 engaged at an angle α facilitates pressing against sealing surface 17 of second component 16b and can, for example, already provide contact pressure thereagainst. In particular, brush element 18 is subjected to a biasing pressure toward first component 16a, which is provided by the arrangement of housing 20 and stop element 30.

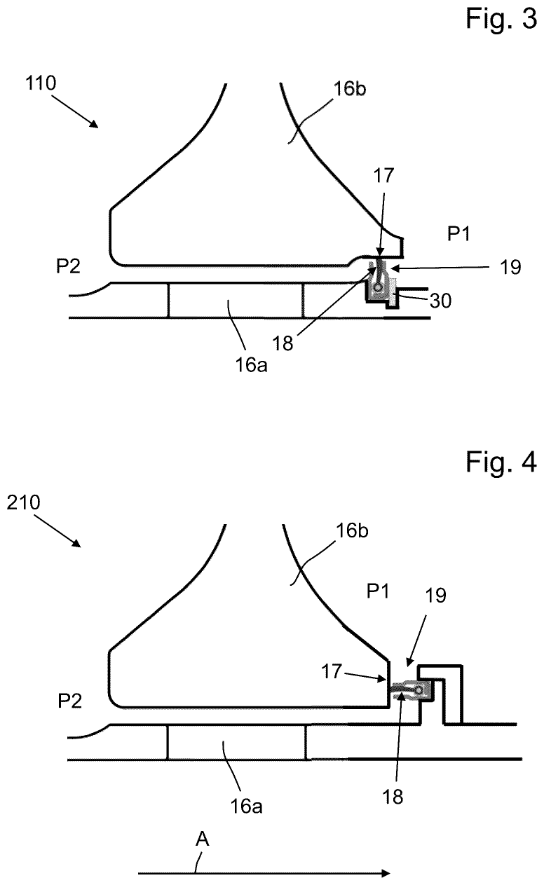

FIG. 3 shows, in sectional view, an exemplary sealing device 110 according to a further embodiment of the invention. This differs from the embodiment of FIG. 2 in that the brush element 18 for forming brush seal 19 is oriented perpendicular to the direction of rotation, i.e., in a radial direction. In this example, sealing surface 17 also faces in a radial direction. That is, in this example, it has a surface normal extending in a radial direction. This has the advantage that the centrifugal force acts along the orientation of the bristles. This can effectively prevent transverse deflection of the bristles and/or improve or reliably ensure a sealing effect.

FIG. 4 shows, in sectional view, an exemplary sealing device 210 according to a further embodiment of the invention. This differs from the embodiment of FIG. 2 in that the brush element 18 for forming brush seal 19 is oriented parallel to the direction of rotation, i.e., in an axial direction. In this example, sealing surface 17 also faces in an axial direction. That is, in this example, sealing surface 17 has a surface normal extending in an axial direction. This has the advantage that in the case of relative axial displacements (e.g., of more than 1 mm, e.g., in the range from 1 mm to 2 mm) along the direction of the axis of rotation (axial direction), brush seal 19 can effectively compensate for the axial displacements while keeping fretting wear to advantageously low levels. In the example of FIG. 4, angle α between the surface of sealing surface 17 and the brush element 18 placed thereagainst is also 90°, just as in the example of FIG. 3.

### LIST OF REFERENCE CHARACTERS

10 sealing device
11 sealing ring
14 gap
16a first component
16b second component
17 sealing surface
18 brush element
18a first end region of the brush element
18b second end region of the brush element
19 brush seal
20 housing
30 stop element
α angle
A axis of rotation
P1 first pressure zone
P2 second pressure zone

What is claimed is:

1-12. (canceled)

13. A sealing device comprising:
at least one brush element for sealing a gap between a first component and a second component, the brush element being attached or fixed to the first component and resting against or contacting a sealing surface of the second component in order to form a brush seal and seal off two pressure zones with different pressures from each other during normal operation, the first component and the second component being rotor components.

14. The sealing device as recited in claim 13 wherein the first component and the second component rotate at a same speed during operation.

15. The sealing device as recited in claim 13 wherein the first component and the second component are disposed such that they are immovable relative to each other during operation, substantially without the relative position of the two components changing during normal operation.

16. The sealing device as recited in claim 13 wherein the first component is a shaft or the second component is a disk or a blisk.

17. The sealing device as recited in claim 13 wherein the brush element is pressed against the sealing surface of the second component by a pressure difference between the two pressure zones with different pressures.

18. The sealing device as recited in claim 13 wherein the brush seal rests against the sealing surface of the second component at an angle between 10° and 90°.

19. The sealing device as recited in claim 13 wherein the gap is a radial gap,

20. The sealing device as recited in claim 19 wherein the gap is a turbomachine gap.

21. The sealing device as recited in claim 13 wherein the brush element is quasi-statically disposed between the two components, and the two components move together substantially without a relative position of the two components being changed or changeable.

22. The sealing device as recited in claim 13 wherein on a side of the brush element opposite the gap, in an axial direction of the turbomachine, a stop element is disposed on the first component to fix the brush element in place and prevent the brush element from shifting.

23. The sealing device as recited in claim 13 wherein the bristle material of the brush element includes a thermoplastic, a meta-aramid, polyether ether ketone (PEEK), ceramic, or a metal.

24. A turbomachine comprising the sealing device as recited in claim 13, configured to seal off the two pressure zones with the different pressures from each other.

25. An aircraft engine comprising the sealing device as recited in claim 13, configured to seal off the two pressure zones with the different pressures from each other.

26. A method comprising employing the sealing device as recited in claim 13 in a turbomachine.

27. A method comprising employing the sealing device as recited in claim 13 in an aircraft engine.
